(19) United States
(12) Patent Application Publication
(10) Pub. No.: US 2009/0186686 A1
(43) Pub. Date: Jul. 23, 2009

(54) GAMING SYSTEM AND METHOD OF GAMING

(75) Inventor: Michael Allan Shai-Hee, Kingsgrove (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, North Ryde (AU)

(21) Appl. No.: 12/357,010

(22) Filed: Jan. 21, 2009

(30) Foreign Application Priority Data
Jan. 21, 2008 (AU) 2008900266

(51) Int. Cl. A63F 9/24; A63F 13/00

(52) U.S. Cl. 463/20; 463/30

(57) ABSTRACT

Gaming system(s) and/or method(s) of gaming are provided in which a plurality of symbols are selected from a set of symbols for play of the game. A display displays selected symbols at symbol positions in rows and columns. The symbols are rearranged so that at least one of selected symbols moves to a different symbol position. In an embodiment, a row of symbols may be rotated so that the row becomes a column. In another embodiment, a column of symbols may be rotated so that the symbols move to symbol positions in a row. A game outcome is based on patterns of the symbols in the row and column positions.

### CROSS-REFERENCE TO RELATED APPLICATIONS

The present application claims the benefit of priority to Australian Provisional Patent Application No. 2008900266, filed on Jan. 21, 2008, entitled “CONVERTING THE REEL COLUMN AS A ROW AND VICE VERSA”, which is herein incorporated by reference in its entirety.

### FIELD OF THE INVENTION

The present invention relates to a gaming system and to a method of gaming.

### BACKGROUND OF THE INVENTION

It is known to provide a gaming system which includes a game controller arranged to randomly select and cause the display of several symbols from a predetermined set of symbols and to determine a game outcome, such as a game win, based on the displayed symbols. Such gaming systems may commonly be implemented as a stepping machine provided with reels with each reel carrying several symbols of the set, or a video machine wherein selected symbols are displayed on virtual reels on a graphical display device. Win outcomes can occur based on symbols appearing in one or more horizontal lines, diagonal lines, or any other predetermined way. Typically five reels across are provided on the display (although less or more may be provided). Each reel or virtual reel display is three symbols high in the display window for the reel (although, again, this may be more or less symbols high).

In many countries, the regulations prescribe that the number of available symbols to select from be a fixed number. With stepper reels this is implemented by having a fixed number of symbols on each reel. With video implementation or other “virtual” reel implementations this is implemented in a similar manner, by allowing only a predetermined number of symbols for each virtual reel. A problem with requiring a fixed number of reel “stops”, whether virtual or stepper, is that this limits the number of combinations that a typical reel game can provide for entertainment of the player.

It is known to provide “feature” games to provide more opportunities for prize winning and increase entertainment. Whilst such gaming systems provide users with enjoyment, the need exists for alternative gaming systems in order to maintain or increase player enjoyment.

### SUMMARY OF THE INVENTION

In accordance with a first aspect, the present invention provides a gaming system, including a game controller arranged to control play of a game, and a display arranged to display representations of play of the game, the game controller being arranged to select a plurality of symbols from a set of symbols for play of the game, and control the display to display a plurality of the selected symbols in symbol positions in rows and columns, the game controller being arranged to rearrange the symbols so that at least one of the selected symbols moves to a different symbol position, and being arranged to determine a game outcome based on patterns of symbols in the row and column positions.

It is an advantage of at least an embodiment of the invention, that moving at least one of the symbol positions to a different position enables a different pattern of symbols to be achieved in addition to the originally selected symbols and symbol positions, to enable more combinations of symbol patterns to be achieved for the determination of game outcomes.

The symbol patterns may include one or more lines, or any other pattern or combination of symbols.

In an embodiment, the game controller is arranged to rearrange the symbol positions so that the at least one symbol moves from one column into another column.

In an embodiment, the game controller is arranged to rotate at least a part of a column of symbols so that the at least part of a column rotates into a row.

In an embodiment, the game controller is arranged to rotate at least a part of a row of symbols so that the part of a row rotates into a column.

In an embodiment, the game controller is arranged to control the display to change the number of symbol positions available.

In an embodiment, the number of symbol positions is increased.

In an embodiment, the symbol may be moved into a new symbol position provided by the expanded display.

In an embodiment, the game controller is arranged to control the display to display the rearranged symbol positions. In an embodiment, the game controller is arranged to control the display to show movement of the symbols as they are moved to the re-arranged symbol positions.

In an embodiment, the gaming system further includes a player interface via which the player may actuate the rearrangement of the symbol positions. At least an embodiment has the advantage of creating a graphically interesting game operation in order to increase player entertainment and interest.

In an embodiment, the rows and columns of symbol positions are represented on the display as a reel bearing the symbols, or is an actual reel bearing the symbols.

In an embodiment, the game may be played utilising player credit.

In an embodiment, an opportunity to rearrange the symbol positions may be bought by the player, based on player credit.

In accordance with a second aspect, the present invention provides a method of gaming, including the steps of selecting a plurality of symbols from a set of symbols for play of a game, controlling the display to display at least a plurality of the selected symbols in symbol positions in rows and columns, rearranging the symbol positions so that at least one of the selected symbols moves to a different symbol position, and determining a game outcome based on combining of patterns of symbols in the row and column positions.

In accordance with a third aspect, the present invention provides a computer program including instructions for controlling a computer to implement a gaming system in accordance with a first aspect of the invention.

In accordance with a fourth aspect, the present invention provides a computer readable medium providing a computer program in accordance with the third aspect of the invention.

In accordance with a fifth aspect, the present invention provides a data signal, including a computer program in accordance with the third aspect of the invention.

In accordance with a sixth aspect, the present invention provides a game controller for a gaming system, arranged to select a plurality of symbols for play of a game, and to control a display to display a plurality of the selected symbols in symbol positions in rows and columns, the game controller being arranged to rearrange the symbols so that at least one of the selected symbols moves to a different symbol position, and being arranged to determine a game outcome based on patterns of symbols in the row and column positions.

In accordance with a seventh aspect, the present invention provides a computer program, including instructions to control a computer to implement a game controller in accordance with the sixth aspect of the invention.

In accordance with an eighth aspect, the present invention provides a computer readable medium, providing a computer program in accordance with the seventh aspect of the invention.

In accordance with a ninth aspect, the present invention provides a data signal in accordance with the seventh aspect of the invention.

In accordance with a tenth aspect, the present invention provides a game controller for a gaming system, arranged to select a plurality of symbols for play of a game, and to control a display to display a plurality of the selected symbols at symbol positions in rows and columns, the game controller being arranged to control the display to change the number of symbol positions.

In accordance with an eleventh aspect, the present invention provides a method of playing a game, including the steps of selecting a plurality of symbols from a set of symbols for play of the game, controlling the display to display at least a plurality of the selected symbols at symbol positions in rows and columns, and changing the number of available symbol positions.

In accordance with a twelfth aspect, the present invention provides a computer program, including instructions for controlling a computer to implement a game controller in accordance with the tenth aspect of the invention.

In accordance with a thirteenth aspect, the present invention provides a computer readable medium, providing a computer program in accordance with the twelfth aspect of the invention.

In accordance with a fourteenth aspect, the present invention provides a data signal, including a computer program in accordance with the twelfth aspect of the invention.

### BRIEF DESCRIPTION OF THE FIGURES

Features and advantages of the present invention will become apparent from the following description of embodiments thereof, by way of example only, with reference to the accompanying drawings, in which;

FIG. 1 is a schematic block diagram of core components of a gaming system in accordance with an embodiment of the present invention;

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of the gaming machine shown in FIG. 2;

FIG. 5 is a schematic diagram of a gaming system in accordance with an alternative embodiment of the present invention with the gaming system implemented over a network;

FIG. 6 is a schematic diagram of functional components of a gaming system in accordance with an embodiment of the present invention;

FIGS. 7 to 13 are schematic representations of example displays generated by a gaming system in accordance with an embodiment of the present invention.

FIG. 14 is a flow diagram illustrating operation of a gaming system in accordance with an embodiment of the present invention, and

FIGS. 15 to 18 are schematic representations of further example displays generated by a gaming system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF EMBODIMENTS

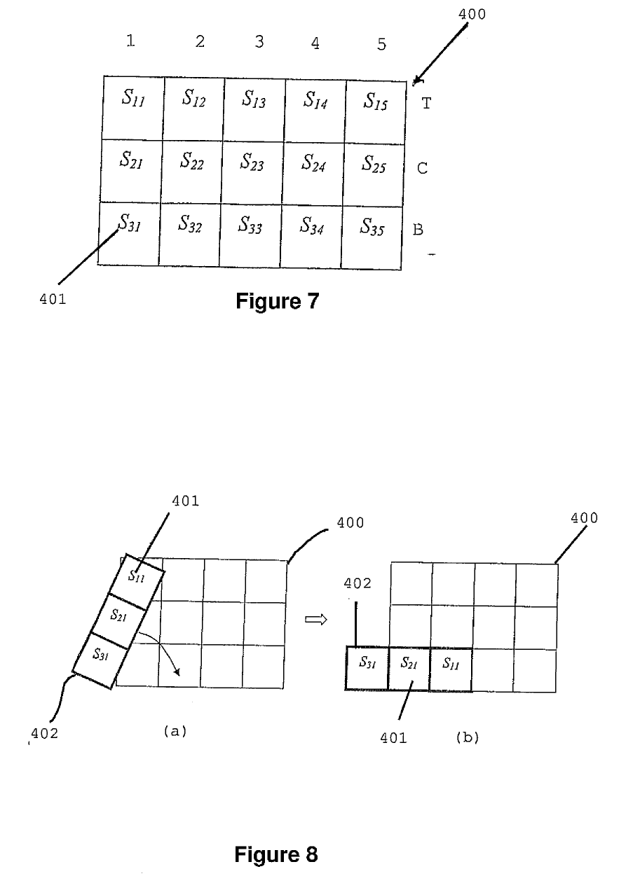

Referring to the drawings, there is shown a gaming system arranged to implement a game in which a plurality of symbols from a set of symbols is selected and displayed in symbol positions in rows and columns. FIG. 7 shows a schematic example of a display 400 with symbols 401 displayed in a plurality of rows and columns. In this embodiment, the game controller is arranged to rearrange the symbol positions (and control the display to show this) so that at least one of the selected symbols moves to a different symbol position. Referring to FIG. 8, this shows a rotation of column 1 (reference no. 402) of the display of FIG. 7, so that symbols S₁₁ and S₂₁ now appear in columns 2 and 3 (FIG. 8(b)), respectively. The rearrangement of symbols S₂₁ and S₁₁ advantageously allows the game controller to make additional patterns of combinations of symbols from which prizes may be awarded to the player, allowing additional opportunity to award prizes to the player and increased entertainment to the player. Many different symbol re-arrangements may be carried out in accordance with this embodiment of the invention.

The gaming system can take a number of different forms.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

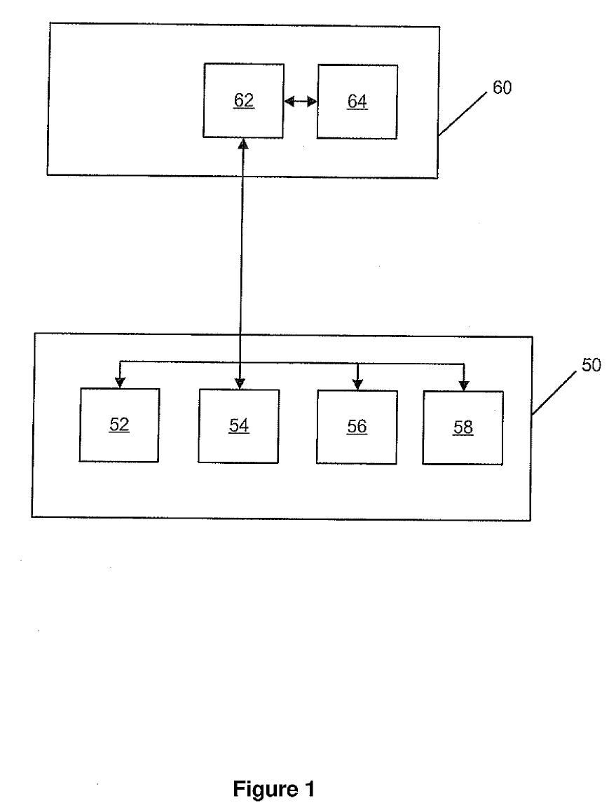

Irrespective of the form, the gaming system includes several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions (e.g. to place bets), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

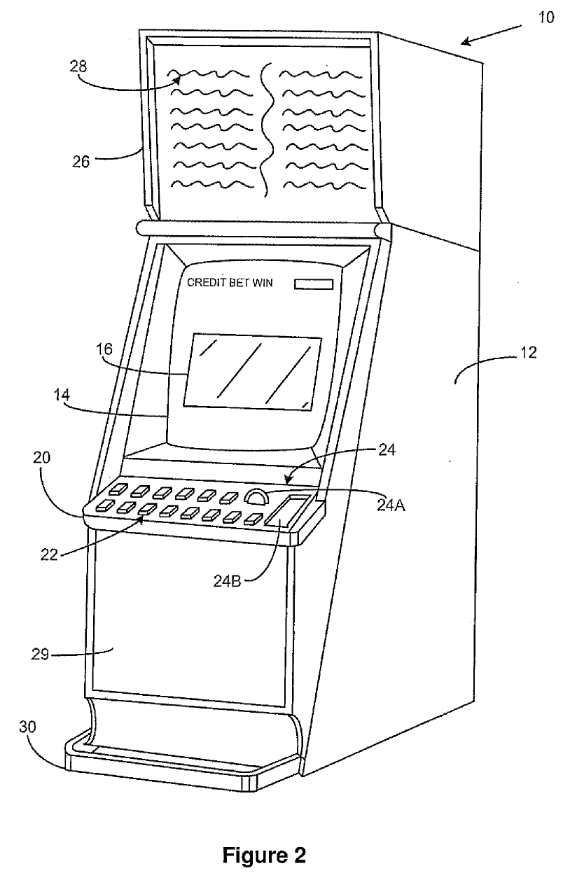

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during gameplay. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

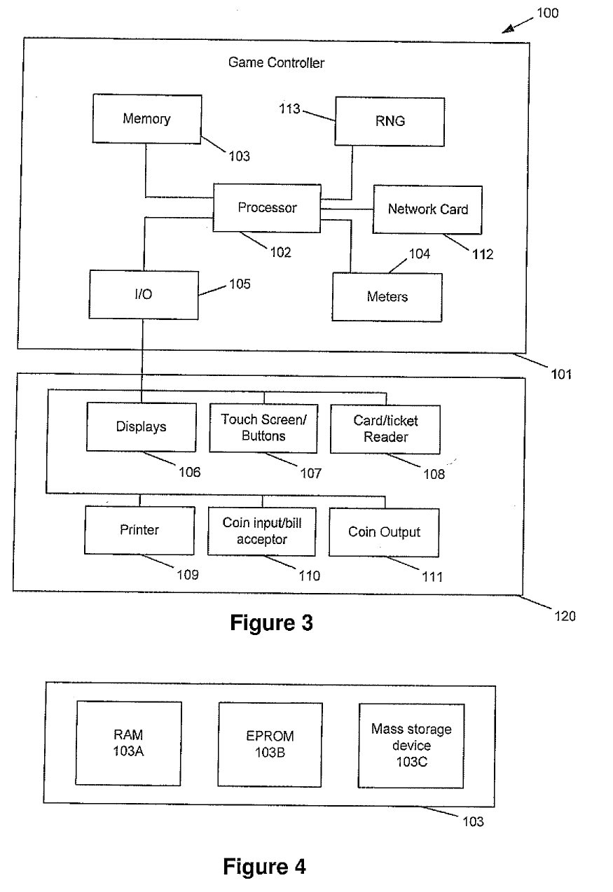

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 include one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

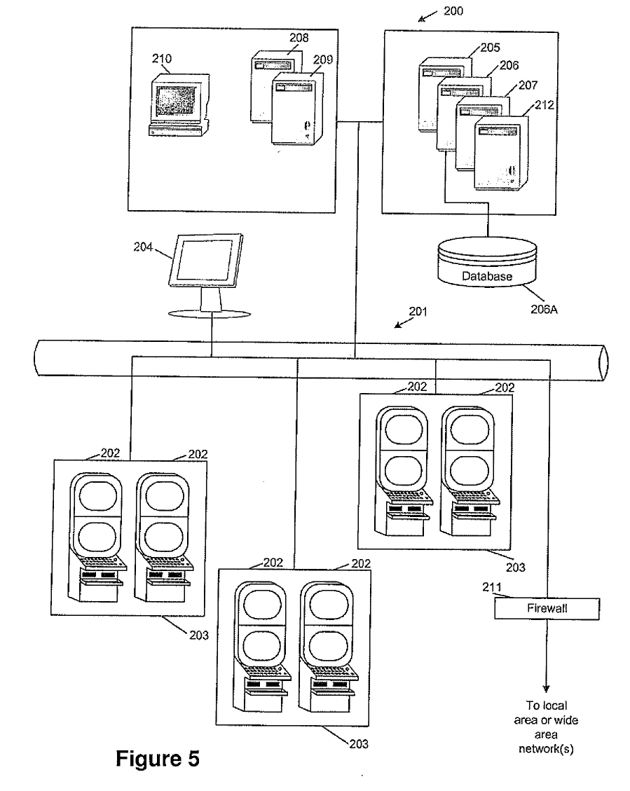

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10, 100, respectively, shown in FIGS. 2 and 3, or may have simplified functionality depending on the guidelines and/or rules for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games based on the terminals.

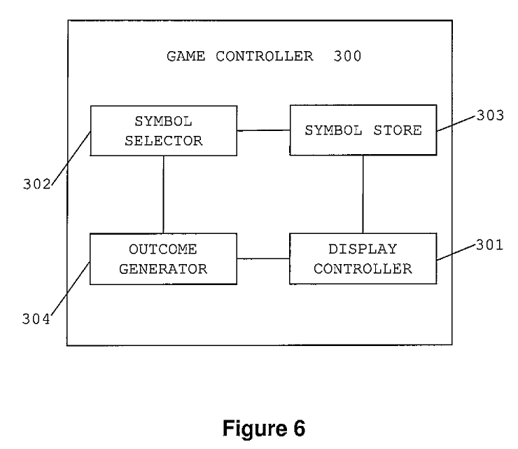

Referring to FIG. 6, the functionality of embodiments of the present invention may be implemented by a game controller having the functional components illustrated. In this embodiment, the functional components are implemented utilizing a processor and memory (such as processor 102 and memory 103 in FIG. 3, or processor 62 and memory 64 in FIG. 1, for the game server 205 in FIG. 5), and associated programming. Other implementations are envisaged. For example the functional blocks of FIG. 6 may be implemented in hardware as separate units, or a combination of hardware and software as separate units. Any practical implementation of these functional units may be employed.

In this embodiment, the game controller 300 is arranged to control the gaming system to play a game which includes selection of a plurality of symbols from a set of symbols. The game is implemented as a “reel” game. The game controller 300 includes a display controller 301 which is arranged to control the display (reference numerals 54, 14, 106, 204 of previous figures) to emulate a representation of reels bearing symbols. Alternatively, the display may include a stepper motor and physical reels bearing the symbols.

The game controller 300 includes a symbol selector 302 which is arranged to select a plurality of symbols from a set of symbols available in a symbol store 303. An outcome generator 304 is arranged to determine an outcome of the game. In this embodiment, the outcome of the game depends on the selected symbols and may include a win outcome, loss outcome, trigger outcome, a feature outcome or other outcome. Outcomes may be determined on the basis of symbols appearing in one or more horizontal lines, diagonal lines, or any other pre-determined combinations.

FIG. 7 shows a schematic representation of a gaming machine display 400 which, in the example shown, has five reels (numbered “1” to “5”). The display 400 shows three reel positions high when the reels have stopped/the symbols have been selected. The reel positions are designated Bottom (“B”), Centre (“C”) and Top (“T”). This is a typical reel-type display for a gaming machine. It will be appreciated that in other embodiments the number of reel positions may be more or less than in display 400. Also the number of reels may be more or less than in the display 400.

The reels may be virtual reels, generated as a video display from the selected symbols, actual mechanical reels carrying the symbols and driven by a stepper motor, or any other reel arrangement or emulation. In the case of actual physical reels, the game controller drives a stepper motor to randomly select the symbols appearing in the display 400.

The game outcome is determined by the outcome generator 304 based on combinations of symbols selected and appearing in the display 400. The symbols may be any symbols. As will be appreciated, many different types of symbols are used in gaming systems. A set of symbols may include standard symbols and function symbols. For example, standard symbols may resemble fruit such as apples, pears and bananas with a win outcome being determined when a predetermined number of the same fruit appear on a display in the same line, scattered, and so on. The function associated with a function symbol may be a “wild” function wherein display of the function symbol is treated during consideration of the game outcome as any of the standard symbols. Other functions may include scatter functions, multiplier functions, repeat win functions, jackpot functions and feature commencement functions.

The symbols may be representations of cards, by which a poker-type card game may be played. In this example, a winning poker hand appearing on the C line may cause the outcome generator to determine that a Win has occurred and that an appropriate prize may be awarded. For example, five of a kind (e.g. 5 jacks “J”. 5 tens “10” etc) on the C line may result in a win. A straight or a straight flush or any other poker combination on the C line may also result in a win.

It will be appreciated that in embodiments of the invention the symbols may be represented in different ways, using any type of fancy artwork, or any appropriate manner.

Operation of an embodiment of the present invention will now be described with reference to FIGS. 7 and 8.

Referring to FIG. 7, the symbol selector 302 selects a plurality of symbols from symbols available from the symbol store 303. The game controller 300 operates via a display controller 301 to emulate spinning of reels in the display 400. The selected symbols 401 are “spun up” on the reels. This is how a conventional video animated reel spinning game operates. The game outcome is determined by the outcome generator 304 depending upon patterns such as line or scatter combinations (or other features such as bonus awards of the symbols appearing in the display 400).

With this basic reel game, however, there are a limited number of symbol combinations available. In this embodiment of the invention, in order to provide further opportunities for awarding of prizes to players, the game controller 300 is arranged to rearrange at least one of the symbols to a different symbol position to provide additional opportunities for combinations which may lead to prize-winning results.

In an embodiment, a plurality of symbols may be rearranged to different symbol positions.

FIGS. 8 (a) and (b) are schematic representations of the display 400 showing how this embodiment of the invention operates to change symbol positions. In this example, the first column (column 1) 402 of symbols 401 is rotated 90° to the right about an axis centering on symbols S₃₁, so that symbols S₂₁ and S₁₁, previously in column 1, are now present in columns 2 and 3, respectively, on the bottom row (B). Symbols S₃₁ and S₂₁ and S₁₁ may now form a line winning combination on the bottom line (B). A player may therefore be entitled to a prize that they were not entitled to before the rotation of the column 402. The game controller may determine an outcome for the initial positioning of the symbols (FIG. 8(a)) and also then make a further determination for an outcome of the selected symbols after rotation has occurred (FIG. 8(b)).

In this embodiment, the chance to obtain a “rotation” may be bought by the player entering extra credit or may be awarded as an outcome of the original symbol selection. A player being able to “buy” rotation rewards a player who is willing to place higher bets, by giving them additional symbol pattern combinations and therefore more chances to win prizes.

A rotation may be awarded to a player on the basis of other criteria than the amount of player credit. It may be awarded on the basis of a trigger combination in the originally selected set of symbols (e.g. a particular scatter combination of symbols, line or row combination or other combination). Other triggers for rotation may include a measurement of time that the player has been playing the machine, a particular amount of waiting activity on the machine, it may be based on player tracking information or may be a random event or any other trigger.

In an embodiment, the player interface may enable player manipulation or actuation to allow the player to activate the rotation. This can be done in any number of ways, for example by touchscreen or a button, as provided by the gaming system.

The player may have the choices as to whether or not to avail themselves of an available rotation, or the gaming system may make the choice for the player.

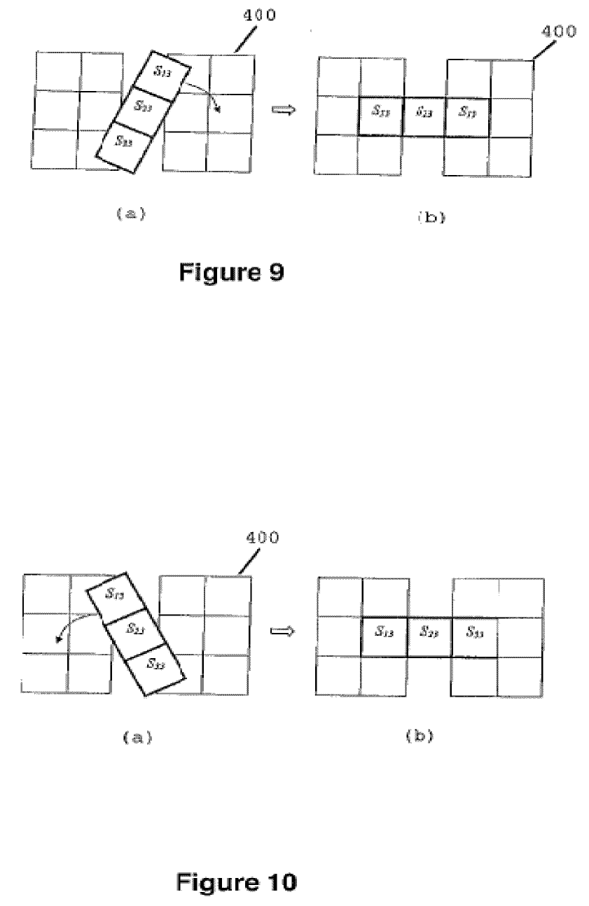

FIGS. 9 to 13 are schematic representations of displays showing other examples of symbol rearrangements that may occur.

FIG. 9 illustrates a rotation of the middle reel column (column 3) 90° to the right with the centre symbol S₂₃ as the axis of rotation. Symbols S₁₃ and S₃₃ now appear in columns 4 and 2, respectively (FIG. 9(b)).

FIG. 10 illustrates a rotation of the centre column 3 anti-clockwise, on axis of symbol S₂₃, so that S₁₃ and S₃₃ now appear in columns 2 and 4 respectively (FIG. 10(b)).

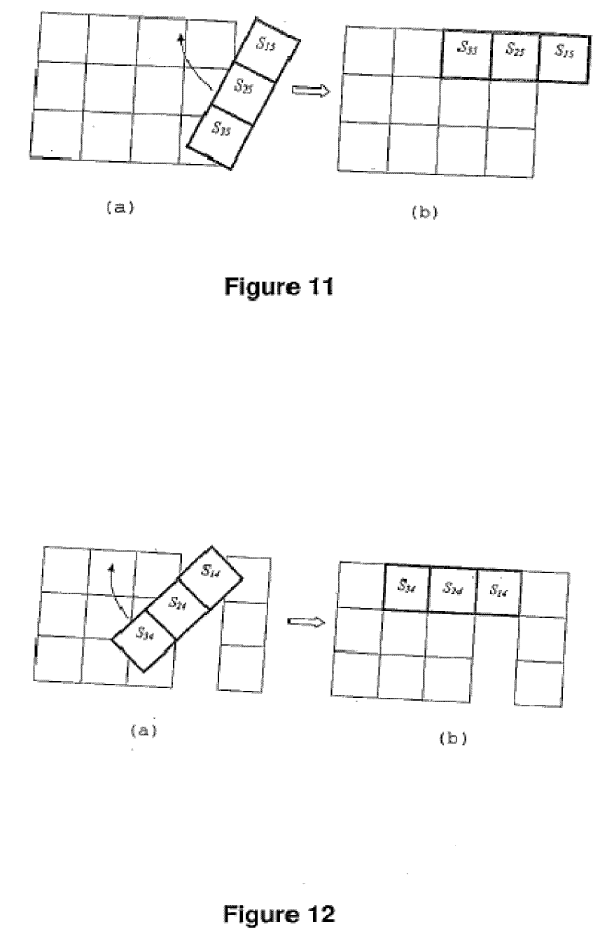

FIG. 11 illustrates a rotation of column 5 about an axis on S₁₅ (top row T) so that symbols S₂₅ and S₃₅ are moved from the centre C and bottom B row respectfully to the top row T, in columns 3 and 4 respectively (FIG. 11(b)).

FIG. 12 illustrates a rotation of column 4 about the symbol S₁₄ so that symbols S₂₄ and S₃₄ move to the top row T, columns 2 and 3 respectively (FIG. 12(b)).

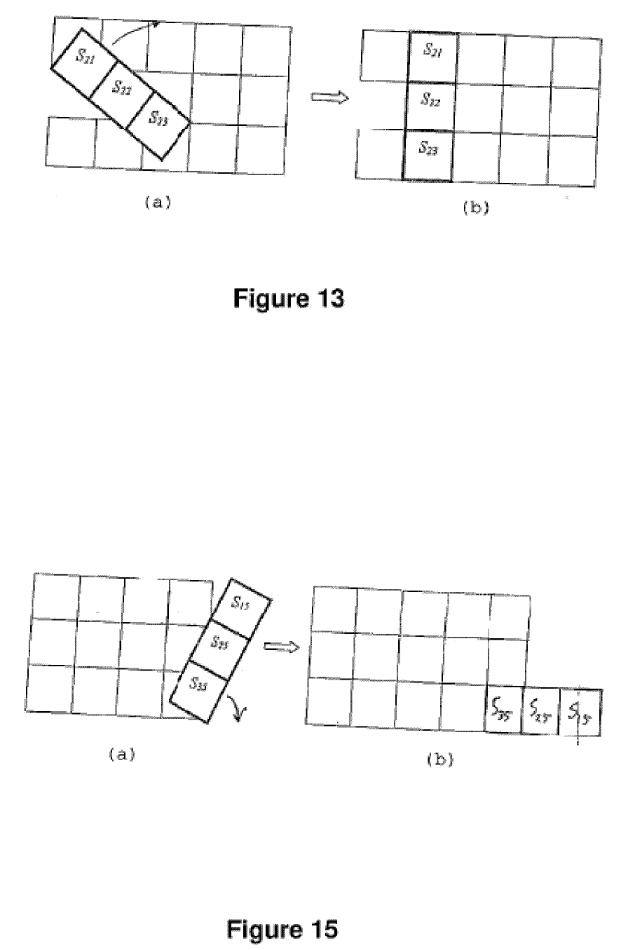

FIG. 13 illustrates a rotation of a row, being three symbols from the centre row B (FIG. 13(a)) about the symbol S₂₂, so that symbols S₂₁ and S₂₃ move from columns 1 and 3 respectively into column 2 (FIG. 13(b)).

The above examples show rotation of columns of symbols into rows and a line of symbols in a row into a column. In each case two symbols are moved about an axis of rotation of the adjacent symbol to the two symbols. The invention is not limited to the two symbols being moved. In another example, four symbols may be moved (e.g. from a row to a column, in which case two of the symbols disappear off the screen and are not considered in any game outcome calculation subsequent to the rotation. In other embodiments a single symbol could be moved and in other embodiments three symbols could be moved.

In a further embodiment, rearrangement may not be by rotation of a column or row. A symbol may merely be transposed from one position to another, for example.

In the above embodiments, a single column or row is shown being rotated.

In other embodiments, more than one row or column may be rotated during a single game.

In an embodiment, rotation of a row or column of symbols may rotate one or more symbols into an area where there were previously no symbol positions shown, or there were symbol positions but they were not being used. Referring to FIG. 15, an embodiment is illustrated where S₁₅, S₂₅ and S₃₅ are rotated so that S₂₅ and S₁₅ effectively provide two extra rows (see FIG. 15(b)), where the bottom row B now includes seven symbol positions, S₂₅ and S₁₅ being the sixth and seventh. Rows T and C remain the same, at 5, 2 symbol positions. An embodiment such as this may be implemented by utilising a video screen, the display controller 301 generating an expanded display on the video screen, showing the extra symbol positions. The new symbol positions can be used in combination with other symbols to determine a game outcome, in accordance with game rules.

In the above described embodiments, the symbol positions that are uncovered when symbols are rotated may remain blank (i.e. they will contain no symbols), see for example FIG. 13. Symbol positions 1C and 3C remain blank when S₂₁ and S₂₃ are rotated to positions 1T and 1B. In an alternative embodiment, these positions 1C and 3C would not remain blank, but would be replaced with other symbols. In one embodiment, the symbol selector may select additional symbols to put in place of symbol positions that are blank. In another embodiment, symbols that have been covered by the rotation (e.g. symbol position 2T and 2B in FIG. 13(b) are moved to the blank symbol positions).

Referring to FIG. 17, for example, when the 4 reel is rotated so that S₂₄ and S₃₄ cover positions 2T and 3T, the symbols originally in those positions, S₁₂ and S₁₃ are moved to positions 4B and 4C respectively. These new symbol combinations can then be used according to game rules to determine a game outcome.

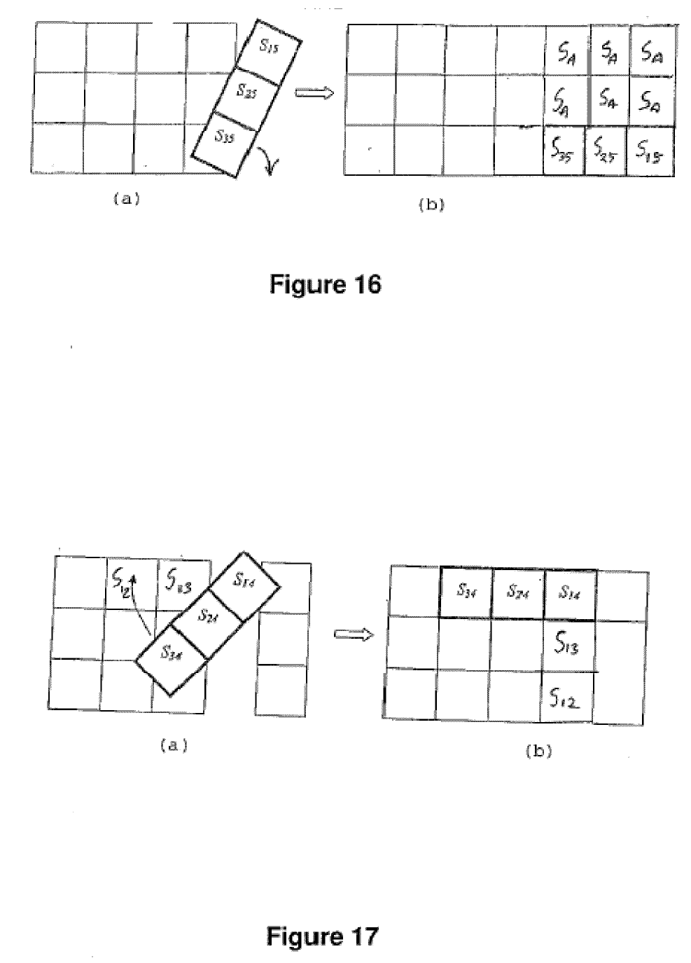

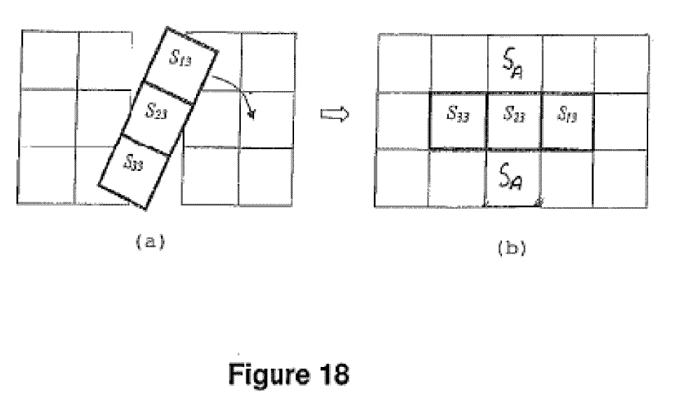

Referring to FIG. 18, the blank symbol positions of 3T and 3B, which has been uncovered by the rotation of the reel about S₂₃, are filled with additional symbols Sₐ, Sₐ which are selected by the symbol selector.

Where the number of symbol positions is increased (such as in the example at FIG. 15, for example) additional symbols may be selected by the symbol selector and put in the new symbol positions provided by the display expansion (see FIG. 16, for example). A rotation about S₃₅ gives an extra 2 reels, in addition to the usual 5 reels. It also removes symbols from symbol positions 5T and 5c. In this embodiment, 6 new symbols S_{A} (which may be different symbols or the same symbols or some different, some the same) are selected, two to fill the positions vacated by S₂₅ and S₁₅, and four to fill the positions made available by the expansion of the display.

Additional symbols S_{A} may be randomly selected. In another embodiment, additional symbols S_{A} could be selected by a player decision from a range of symbols made available for filling vacant symbol positions. Alternatively, additional symbols can be selected according to fixed rules via the game controller.

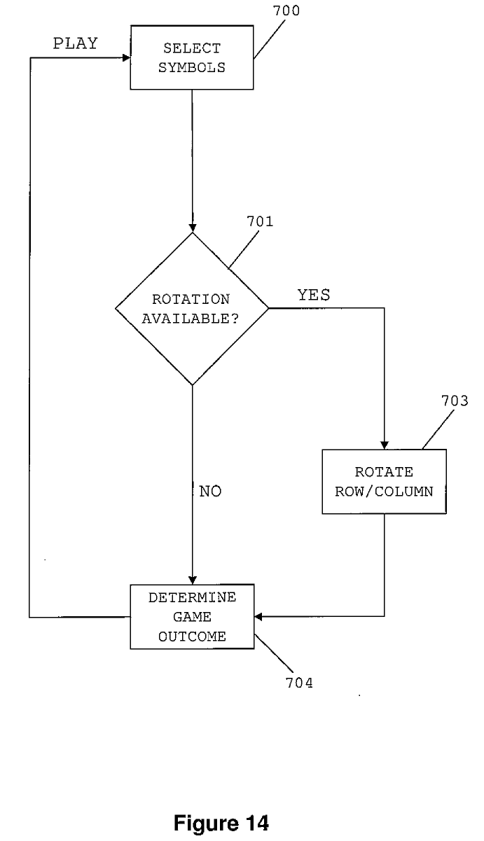

A game playing process in accordance with an embodiment of the present invention will now be summarised with reference to FIG. 14.

At 700, the game is played by a selection of symbols from the symbol store 303 by the symbol selector 302. At 701, a determination is made as to whether or not any symbol rearrangement is available (in this embodiment being a rotation of a column or a row). As discussed above, symbol rearrangements may be made available depending on any number of predetermined criteria (including whether the player has entered credits to “buy” a symbol re-arrangement). If a rearrangement is available, at 703, the game controller 300 rotates the row/column of symbols. If no rotation is available, the game outcome is determined at 704 on the basis of only the originally selected symbols. Where rotation has occurred, game outcome is determined based on the originally selected symbols and the symbol patterns following the rotation (704).

In the above embodiments, the game controller 300 causes the display controller 301 to show the symbol rearrangement appearing on the display. In an alternative embodiment, the game controller 300 may perform the symbol rearrangement internally, and award prizes accordingly, but not necessarily show the symbol rearrangement on the display.

In the above embodiments, the location of the symbols to be re-arranged is selected by the gaming system. In some circumstances, there may be a plurality of the symbols that may be selected for a re-arrangement and the player interface may enable the player to select which symbols are re-arranged. For example, all the symbols on the display may be available for re-arrangement by rotating columns into rows or rows into columns. The player selects which ones he wants to move. He may have one or more choices, for example. In another example, only a limited number of symbols present in the display may be available for re-arrangement by the player.

In the above described embodiments, the display emulates a plurality of reels.

In an alternative embodiment, the original symbol selection may be implemented as actual reels driven by a stepper motor. The symbol rearrangement may be implemented by video graphics overlaying the display of the actual stepper reels.

In another embodiment, the display may not emulate reels, but merely show the selected symbols in a non-reel format (e.g. presenting them as emulated playing cards, or other representations of a series of rows and columns of symbols.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood to persons skilled in the art of the invention that many modifications may be made without departing from the spirit and scope of the invention.

It will be appreciated by persons skilled in the art that numerous variations and/or modifications may be made to the invention as shown in the specific embodiments and/or aspects without departing from the spirit or scope of the invention as broadly described. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system, comprising a game controller arranged to control play of a game, and a display arranged to display representations of play of the game, the game controller being arranged to select a plurality of symbols from a set of symbols for play of the game, and control the display to display a plurality of the selected symbols in symbol positions in rows and columns, the game controller being arranged to rearrange the symbols so that at least one of the selected symbols moves to a different symbol position and being arranged to determine a game outcome based on patterns of symbols in the row and column positions.

2. A gaming system in accordance with claim 1, wherein the game controller is arranged to re-arrange the symbols so that the at least one symbol moves from one column into another column.

3. A gaming system in accordance with claim 2, wherein the game controller is arranged to rotate at least part of a column of symbols so that the at least part of a column rotates into a row.

4. A gaming system in accordance with claim 2, wherein the game controller is arranged to rotate at least a part of a row of symbols so that the part of a row rotates into a column.

5. A gaming system in accordance with claim 1, wherein the controller is arranged to control the display to change the number of symbol positions.

6. A gaming system in accordance with claim 5, wherein the game controller is arranged to control the display to increase the number of symbol positions, by creating new symbol positions.

7. A game controller in accordance with claim 6, being arranged to rearrange the symbols so that at least one of the symbols moves into a newly created symbol position.

8. A gaming system in accordance with claim 6, the game controller being arranged to select one or more additional symbols and to utilise the additional symbols in one or more of the new symbol positions.

9. A gaming system in accordance with claim 1, wherein the game controller is arranged to rearrange the symbols so that at least one symbol moves to a symbol position already occupied by a symbol, and replaces the symbol in the already occupied symbol position.

10. A gaming system in accordance with claim 9, wherein the game controller is arranged to move the symbol in the already occupied symbol position to the symbol position from which the at least one symbol has been moved.

11. A gaming system in accordance with claim 1, further comprising a player interface arranged to enable a player to actuate the re-arrangement of the symbols.

12. A gaming system in accordance with claim 1, the game controller being arranged to provide a player with an opportunity to re-arrange the symbols based on player credit.

13. A gaming system in accordance with claim 1, wherein the game controller and display are implemented over stand alone game machine.

14. A gaming system in accordance with claim 1, wherein the game controller and display are implemented by a gaming server and gaming architecture.

15. A method of gaming, comprising the steps of selecting a plurality of symbols from a set of symbols for play of a game, controlling a display to display at least a plurality of the selected symbols in symbol positions in rows and columns, rearranging the symbols so that at least one of the selected symbols moves to a different symbol position, and determining a game outcome based on patterns of symbols in the row and column positions.

16. A method in accordance with claim 15, wherein the step of re-arranging the symbols comprises the step of moving the at least one symbol from one column into another column.

17. A method in accordance with claim 16, wherein the step of re-arranging the symbols comprises rotating at least part of a column of symbols so that the at least part of a column rotates into a row.

18. A method in accordance with claim 16, wherein the step of re-arranging the symbols comprises rotating at least a part of a row of symbols so that the part of a row rotates into a column.

19. A method in accordance with claim 15, comprising the step of increasing the number of available symbol positions, by creating new symbol positions.

20. A method in accordance with claim 19, wherein the step of rearranging the symbols comprises moving at least one of the symbols into a new symbol position.

21. A method in accordance with claim 19, comprising the step of selecting one or more additional symbols and utilising the additional symbols in one or more of the new symbol positions.

22. A method in accordance with claim 15, wherein the step of rearranging the symbols comprises moving at least one symbol to a symbol position already occupied by a symbol, and replacing the symbol in the already occupied symbol position.

23. A method in accordance with claim 22, comprising the step of moving the symbol in the already occupied symbol position to the symbol position from which the at least one symbol has been moved.

24. A method in accordance with claim 15, comprising the further step of providing an opportunity for a player to buy a symbol position re-arrangement on the basis of player credit.

25. A computer readable medium including a computer program comprising instructions for controlling a computer to implement a gaming system, the gaming system comprising:
a game controller arranged to control play of a game, and
a display arranged to display representations of play of the game,
the game controller being arranged to select a plurality of symbols from a set of symbols for play of the game, and control the display to display a plurality of the selected symbols in symbol positions in rows and columns, the game controller being arranged to rearrange the symbols so that at least one of the selected symbols moves to a different symbol position and being arranged to determine a game outcome based on patterns of symbols in the row and column positions.

26. A game controller for a gaming system, arranged to select a plurality of symbols for play of a game, and to control a display to display a plurality of the selected symbols in symbol positions in rows and columns, the game controller being arranged to rearrange the symbols so that at least one of the selected symbols moves to a different symbol position, and being arranged to determine a game outcome based on patterns of symbols in the row and column positions.

27. A game controller in accordance with claim 26, arranged to rearrange the symbols so that at least one symbol moves from one column into another column.

28. A game controller in accordance with claim 27, arranged to rotate at least part of a column of symbols so that the at least part of a column rotates into a row.

29. A game controller in accordance with claim 27, arranged to rotate at least part of a row of symbols so that the part of a row rotates into a column.

30. A game controller in accordance with claim 26, arranged to control the display to change the number of symbol positions.

31. A game controller in accordance with claim 30, arranged to control the display to increase the number of symbol positions, by creating new symbol positions.

32. A game controller in accordance with claim 31, arranged to rearrange the symbols so that at least one of the symbols moves into a new symbol position.

33. A game controller in accordance with claim 31, being arranged to select one or more additional symbols and to utilise the additional symbols in one or more of the new symbol positions.

34. A game controller in accordance with claim 26, arranged to rearrange the symbols so that at least one symbol moves to a symbol position already occupied by a symbol, and replaces the symbol in the already occupied symbol position.

35. A game controller in accordance with claim 34, arranged to move the symbol in the already occupied symbol position to the symbol position from which the at least one symbol has been moved.

37. A computer readable medium including a computer program comprising instructions for controlling a computer to implement a game controller for a gaming system, the game controller arranged to select a plurality of symbols for play of a game, and to control a display to display a plurality of the selected symbols in symbol positions in rows and columns, the game controller being arranged to rearrange the symbols so that at least one of the selected symbols moves to a different symbol position, and being arranged to determine a game outcome based on patterns of symbols in the row and column positions.

38. A game controller for a gaming system, arranged to select a plurality of symbols for play of a game, and to control a display to display a plurality of the selected symbols in symbol positions in rows and columns, the game controller being arranged to control the display to change the number of symbol positions.

39. A game controller in accordance with claim 38, arranged to control the display to increase the number of symbol positions, by creating new symbol positions.

40. A gaming system, comprising a game controller in accordance with claim 39 and a display.

41. A method of playing a game, comprising the steps of selecting a plurality of symbols from a set of symbols for play of the game, controlling a display to display at least a plurality of the selected symbols at symbol positions in rows and columns, and changing the number of available symbol positions.

42. A method in accordance with claim 41, wherein the step of changing the number of available symbol positions comprises the step of creating new symbol positions.

43. A computer readable medium including a computer program comprising instructions for controlling the computer to implementing a game controller for a gaming system, the game controller arranged to select a plurality of symbols for play of a game, and to control a display to display a plurality of the selected symbols in symbol positions in rows and columns, the game controller being arranged to control the display to change the number of symbol positions.
